(19) United States
(12) Patent Application Publication
(10) Pub. No.: US 2023/0116996 A1
(43) Pub. Date: Apr. 20, 2023

(54) REDUCTANT INJECTION SYSTEM AND METHOD FOR SELECTIVE CATALYTIC REDUCTION REACTION

(71) Applicant: DAEYOUNG C&E, Gangwon-do (KR)

(72) Inventors: Sei Youn Noh, Gangwon-do (KR); Nam Ha Kim, Gangwon-do (KR); Byung Han Seo, Gangwon-do (KR); Myoung Jin Kha, Gangwon-do (KR); Hyo Sang Lee, Gangwon-do (KR)

(21) Appl. No.: 16/977,149

(22) PCT Filed: Dec. 13, 2019
(86) PCT No.: PCT/KR2019/017696

§ 371 Date: Sep. 1, 2020

(30) Foreign Application Priority Data
Sep. 17, 2019 (KR) 10-2019-0114339

(51) Int. Cl. B01D 53/90; B01D 53/86; B01J 23/18; B01J 21/06; B01J 23/10; B01J 37/08

(52) U.S. Cl. CPC B01D 53/90; B01D 53/8631; B01J 23/18; B01J 21/066; B01J 23/10; B01J 37/08; B01D 2251/2067

(57) ABSTRACT

The present disclosure relates to reductant injection system and method for a selective catalytic reduction reaction whereby urea is injected directly to an exhaust line where a denitrification reaction occurs without using an additional urea decomposition reactor and, thus, conversion from urea to ammonia can occur very fast.

### TECHNICAL FIELD

The present disclosure relates to reductant injection system and method for a selective catalytic reduction reaction, more particularly to reductant injection system and method for a selective catalytic reduction reaction whereby urea is injected directly to an exhaust line where a denitrification reaction occurs without using an additional urea decomposition reactor.

### BACKGROUND ART

Nitrogen oxide (NOₓ) is produced mainly from the combustion of fossil fuels and is generated from mobile sources such as ships or automobiles or stationary sources such as power plants or incinerators. The nitrogen oxide is regarded as one of the main causes that pollute the atmosphere through acid rain and smog. As the regulations on air pollution are becoming stricter recently, a lot of researches are being conducted on the reduction of nitrogen compounds such as nitrogen oxide using reductants.

As a method for removing nitrogen compounds exhausted from stationary sources, a nitrogen dioxide conversion catalyst, which uses ammonia, etc. as a reductant, titanium dioxide (titania, TiO₂) as a support and vanadium oxide (V₂O₅) as an active catalytic component, is widely used.

However, ammonia has a problem to be used in a selective catalytic reduction reaction because the efficiency of selective catalytic reduction decreases abruptly as the ammonia forms ammonium nitrate at 170° C. or lower and additional heat source and apparatus are required to produce ammonia from urea.

### DISCLOSURE OF THE INVENTION

### Technical Problem

The present disclosure is directed to providing a system and a method capable of producing and supplying a reductant from urea using a heat source of an exhaust gas system maintained at high temperature.

### Technical Solution

The present disclosure provides a reductant injection system for a selective catalytic reduction reaction, which includes: an exhaust gas line wherein an exhaust gas comprising nitrogen oxide (NOₓ) flows; a urea reservoir provided outside the exhaust gas line, wherein urea is stored; and a urea injection line for injecting urea from the urea reservoir to the exhaust gas line.

### Advantageous Effects

A reductant injection system for a selective catalytic reduction reaction of the present disclosure allows very fast conversion from urea to ammonia by directly injecting urea to an exhaust gas line without an additional ammonia conversion reactor.

### BRIEF DESCRIPTION OF THE DRAWINGS

FIGS. 1-3 schematically show ammonia production systems according to the present disclosure.

FIG. 4 shows ammonia yield depending on urea injection temperature.

FIG. 5 shows urea decomposition activity depending on the change in a catalyst and carrier gas temperature.

FIG. 6 shows urea decomposition activity depending on the change in a catalyst and carrier gas temperature under the space velocity condition of 30,000 hr⁻¹.

FIG. 7 shows the correlation between O_{α}+O_{β}/Oₜₒₜₐₗ and urea conversion rate in examples and comparative examples.

### BEST MODE FOR CARRYING OUT THE INVENTION

The present disclosure can be changed variously and may have various exemplary embodiments. Hereinafter, specific exemplary embodiments will be described in detail referring to the attached drawings.

However, the specific exemplary embodiments are not intended to limit the present disclosure but should be understood to include all changes, equivalents and substitutes included within the spirit and scope of the present disclosure. In the following description of the present disclosure, a detailed description of related known technology may be omitted to avoid unnecessarily obscuring the subject matter of the present disclosure.

The terms used in the present disclosure are intended only to describe the specific exemplary embodiments and are not intended to limit the present disclosure. Unless the context expressly indicates otherwise, singular expressions include plural expressions.

It should be understood that the terms such as “include”, “have”, etc. used in the present disclosure specify the presence of stated features, numbers, steps, operations, elements, components or combinations thereof, but do not preclude the presence or addition of one or more other features, numbers, steps, operations, elements, components or combinations thereof.

In addition, when describing the components of the present disclosure, the terms such as, first, second, A, B, (a), (b), etc. may be used. These terms are not used to define the essence, order, sequence, etc. of the components but merely to distinguish the corresponding elements from other components. If one component is described to be “connected”, “coupled” or “joined” to another component, it should be understood that another component may be “connected”, “coupled” or “joined” between the two components, although the two components may be connected, coupled or joined directly.

The present disclosure relates to reductant injection system and method for a selective catalytic reduction reaction, more particularly to reductant injection system and method for a selective catalytic reduction reaction, whereby urea is injected directly to an exhaust line where a denitrification reaction occurs without using an additional urea decomposition reactor.

Ammonia heretofore used in a selective catalytic reduction reaction to remove nitrogen compounds exhausted from a stationary source has the problem that the efficiency of the selective catalytic reduction reaction decreases abruptly as the ammonia forms ammonium nitrate at 170° C. or lower and additional heat source and apparatus are required to produce ammonia from urea.

The present disclosure has an effect of allowing very fast conversion from urea to ammonia by providing a reductant injection system for a selective catalytic reduction reaction, which is capable of directly injecting urea to an exhaust gas line including nitrogen oxide (NOₓ) without an additional ammonia conversion reactor.

The reductant injection system for a selective catalytic reduction (SCR) according to an exemplary embodiment of the present disclosure reduces nitrogen oxide (NOₓ) included in an exhaust gas exhausted from an engine. The engine may be one or more of a diesel engine used as a main power source and a medium-speed diesel engine used for a power generation or auxiliary power source.

However, the use of the reductant injection system for a selective catalytic reduction reaction according to an exemplary embodiment of the present disclosure is not limited thereto and the reductant injection system can be used for various applications such as vehicles, plants, etc.

Hereinafter, reductant injection system and method for a selective catalytic reduction reaction according to an exemplary embodiment of the present disclosure will be described in more detail referring to FIGS. 1-3.

A reductant injection system 10 for a selective catalytic reduction reaction according to an exemplary embodiment of the present disclosure is configured by including an exhaust gas line 100 wherein an exhaust gas including nitrogen oxide (NOₓ) flows, a urea reservoir 200 provided outside the exhaust gas line 100, wherein urea is stored, and a urea injection line 300 for injecting urea from the urea reservoir 200 to the exhaust gas line 100.

In particular, according to an exemplary embodiment of the present disclosure, there is an advantage that very fast conversion from urea to ammonia can be achieved by directly injecting urea to the exhaust gas line 100 without an additional ammonia conversion reactor.

And, the converted ammonia may be used as a reductant, which catalyzes the chemical reaction of NOₓ as a catalyst, to reduce NOₓ in a combustion gas to N₂ and H₂O. That is to say, ammonia of the same equivalent as nitrogen oxide may be injected into the exhaust gas line 100 wherein an exhaust gas flows for selective reaction in the presence of a catalyst.

The exhaust gas line 100 refers to a fluid line wherein the exhaust gas including nitrogen oxide (NOₓ) flows, and may refer to a fluid line wherein the exhaust gas exhausted from an exhaust gas source flows. The exhaust gas source may be a combustion furnace, a heating furnace or an internal-combustion engine and may be an apparatus that exhausts a noxious gas such as nitrogen oxide, etc. through combustion, synthesis, decomposition, etc. of a material.

The urea reservoir 200 stores urea which is a reductant precursor. The urea may be an aqueous solution consisting of urea ((NH₂)₂CO) and deionized water. The aqueous urea solution may enable downstream transportation.

The urea may be transported to the exhaust gas line 100 through the urea injection line 300, and the urea may be transported from the urea reservoir 200 to the exhaust gas line 100 by the operation of a circulation module.

According to an exemplary embodiment of the present disclosure, there is an advantage that very fast conversion from urea to ammonia can be achieved by directly injecting urea to the exhaust gas line 100 without an additional ammonia conversion reactor. In addition, since the urea has higher melting point, boiling point and solubility than ammonia, it can be selected as a reductant precursor to ensure storage stability, etc.

Meanwhile, the temperature of one point (T₁) of the exhaust gas line 100 connected to the urea injection line 300 may be equal to or higher than the temperature for pyrolyzing the urea (T_{d}). Here, the one point may refer to the point where the urea injection line 300 comes in contact with the exhaust gas line 100, and may refer to the point where the outlet of the urea injection line 300 comes in contact with the inlet of the exhaust gas line 100.

In general, although urea (aqueous urea solution) can be hydrolyzed to ammonia even at room temperature, urea may be thermally hydrolyzed at a temperature equal to higher than its melting point to easily produce ammonia, carbon dioxide and water.

The temperature for pyrolyzing urea (T_{d}) may be 150° C. or higher, specifically 150-220° C. At temperatures below 150° C., urea may not be decomposed easily. And, at temperatures above 220° C., salts that are difficult to decompose such as CYA, ammelide, etc. may be formed when urea is introduced into the exhaust gas line 100.

That is to say, the temperature of one point (T₁) of the exhaust gas line 100 described above may be may be equal to or higher than the temperature for pyrolyzing the urea (T_{d}), which may be 150° C. or higher, 150-220° C., 160-200° C. or 170-190° C.

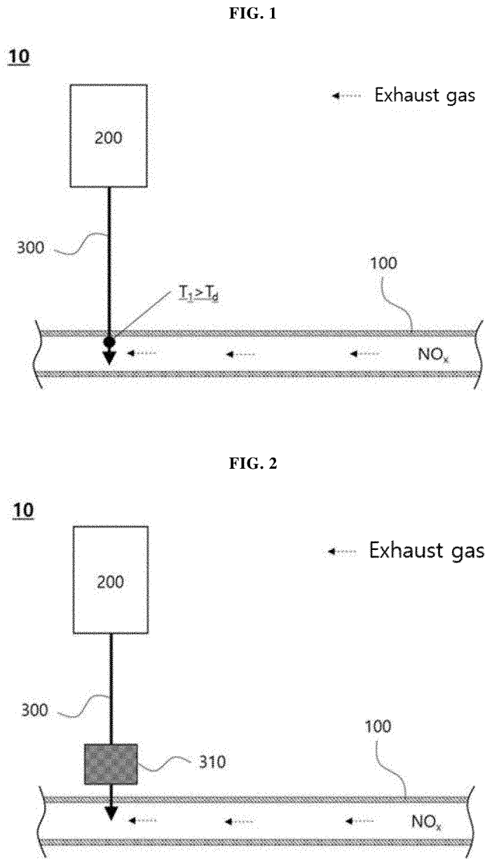

FIG. 2 schematically shows an ammonia production system according to another exemplary embodiment of the present disclosure.

Referring to FIG. 2, an ammonia production system according to another exemplary embodiment of the present disclosure may include a heating means 310 in the urea injection line 300 in order to satisfy the temperature range described above.

The heating means 310 may be a common heater for pyrolyzing urea injected from the urea reservoir 200 to the exhaust gas line 100. In order to pyrolyze urea to ammonia, it may be heated to a temperature of 150° C. or higher with the heating means 210 for a residence time of 1 minute or longer, which is necessary for increasing the temperature. Specifically, the heating temperature may be 150-220° C., 160-200° C. or 170-190° C. That is to say, the temperature of one point (T1) of the exhaust gas line 100 may be 170-190° C.

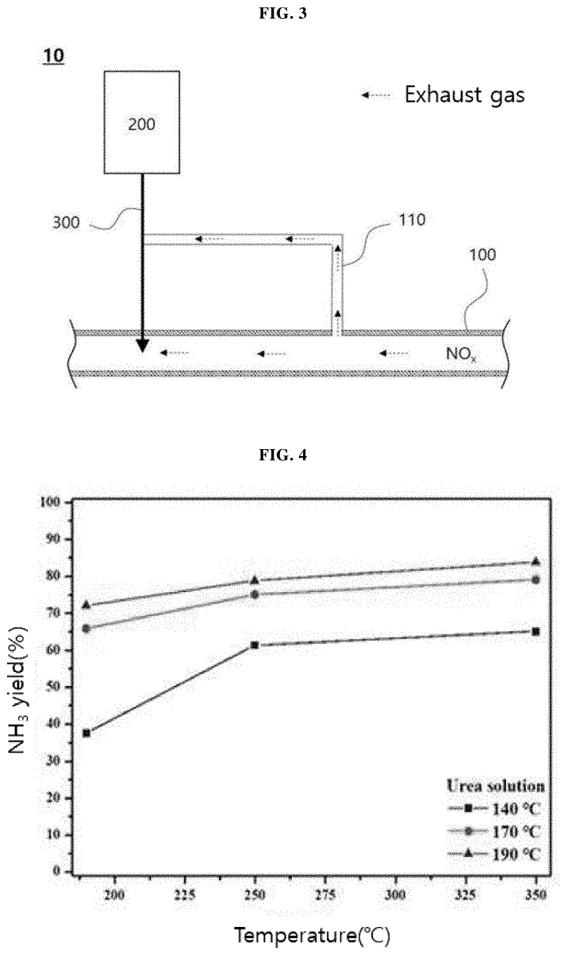

FIG. 3 schematically shows an ammonia production system according to another exemplary embodiment of the present disclosure.

Referring to FIG. 3, an ammonia production system according to another exemplary embodiment of the present disclosure is characterized in that a carrier gas line 110 diverging from the exhaust gas line 100 is connected to the urea injection line 300. Specifically, in the present disclosure, a high-temperature exhaust gas exhausted from an exhaust gas source may be used as a heat source for pyrolyzing urea.

As described above, in the present disclosure, an exhaust gas of about 180-220° C., which is exhausted from an exhaust gas source, is transported to the urea injection line 300 and used as a heat source for pyrolyzing urea to ammonia. The exhaust gas may be supplied to the urea injection line 300 at a flow rate of 7-20 m/s, specifically 10-15 m/s.

In this case, the exhaust gas may be used as a heat source for pyrolyzing urea without an additional heating means 210 and, thus, a reduction reaction with nitrogen oxide can be performed stably and quickly.

That is to say, according to another exemplary embodiment of the present disclosure, the exhaust gas of about 180-220° C., which is exhausted from the exhaust gas source, is transported to the urea injection line 300 and can maintain the temperature of one point (T₁) of the exhaust gas line 100 connected to the urea injection line 300 at a temperature of 150-220° C.

In addition, in the reductant injection system 10 for a selective catalytic reduction reaction of the present disclosure, the urea injection line 300 may be equipped with a catalyst for decomposing the urea to ammonia.

The catalyst for decomposing the urea to ammonia includes a titania support and ceria supported on titania, and the catalyst has an oxygen composition satisfying Equation 1.

0.8<O_{α}+O_{β}/Oₜₒₜₐₗ<0.87 [Equation 1]

In Equation 1, Oₐ represents lattice oxygen, Op represents surface-adsorbed oxygen and Oₜₒₜₐₗ represents total oxygen in the catalyst.

In particular, when the oxygen composition of the catalyst satisfies Equation 1, the conversion efficiency of urea may be 80% or higher.

The urea decomposition catalyst may have a ceria content of 5.0-10.0 wt. % based on the total catalyst. The urea decomposition catalyst may be sintered at a temperature of 350-450° C. to satisfy the oxygen composition of Equation 1.

In addition, the urea decomposition catalyst may further include antimony or zirconia.

In a specific exemplary embodiment, the urea decomposition catalyst may further include antimony, and the content of antimony may be 1.5-2.5 wt. % based on the total catalyst.

The urea decomposition catalyst may be sintered at a temperature of 550-650° C. to satisfy the oxygen composition of Equation 1.

In another exemplary embodiment, the urea decomposition catalyst may further include zirconia, and the content of zirconia may be 1.5-2.5 wt. % based on the total catalyst.

The urea decomposition catalyst may be sintered at a temperature of 450-550° C. to satisfy the oxygen composition of Equation 1.

The urea decomposition catalyst of the present disclosure may be prepared as follows. A ceria/titania catalyst may be prepared by supporting ceria on a titania support and then drying and sintering the same. Then, a urea decomposition catalyst may be prepared by supporting antimony or zirconia on the ceria/titania catalyst and then drying and sintering the same.

In particular, when the sintering temperature is outside the above range, the ability of decomposing urea may decrease. The sintering process may be performed in various types of furnaces including a tube furnace, a convection furnace, a grate furnace, etc., although not being specially limited thereto.

Hereinafter, the present disclosure is described in more detail through examples and test examples.

However, the following examples and test examples merely exemplify the present disclosure and the present disclosure is not limited by the following examples and test examples.

### Examples

### Example 1. Ce/DT51

For preparation of a Ce/DT51 catalyst for decomposing urea to ammonia, an aqueous ceria solution was prepared by mixing ceria nitrate (Ce(NO₃)₃·xH₂O) in distilled water such that the content of ceria was 7 wt. % based on the total weight of the catalyst. After mixing the prepared aqueous ceria solution with titania (DT51) to prepare a slurry and removing water using a rotary vacuum evaporator, the slurry was dried sufficiently in a dryer at 103° C. for at least one day to completely remove water contained in fine pores.

Then, a ceria/titania catalyst was prepared by sintering in a tubular electric furnace at 400° C. for 4 hours under air atmosphere.

### Example 2. Ce/Sb/DT51

For preparation of a Ce/Sb/DT51 catalyst for decomposing urea to ammonia, an aqueous antimony solution was prepared by mixing antimony trioxide in distilled water such that the content was 2 wt. % based on the total weight of the catalyst. After mixing the prepared aqueous antimony solution with titania (DT51) to prepare a slurry and removing water using a rotary vacuum evaporator, the slurry was dried sufficiently in a dryer at 103° C. for at least one day to completely remove water contained in fine pores. Then, an antimony/titania catalyst was prepared by sintering in a tubular electric furnace at 600° C. for 4 hours under air atmosphere.

Subsequently, an aqueous ceria solution was prepared by mixing ceria nitrate (Ce(NO₃)₃·xH₂O) in distilled water such that the content was 7 wt. % based on the total weight of the catalyst. After mixing the prepared aqueous ceria solution with the antimony/titania catalyst to prepare a slurry and removing water using a rotary vacuum evaporator, the slurry was dried sufficiently in a dryer at 103° C. for at least one day to completely remove water contained in fine pores.

Then, a ceria/antimony/titania catalyst was prepared by sintering in a tubular electric furnace at 400° C. for 4 hours under air atmosphere.

### Example 3. Ce/Zr/DT51

A ceria/zirconium/titania catalyst was prepared in the same manner as in Example 2 except that antimony was replaced with zirconium.

The zirconium/titania catalyst was sintered at 500° C. under air atmosphere.

### Comparative Examples

### Comparative Example 1. DT51

Titania (DT51) was prepared.

### Comparative Example 2. Zr/DT51

A zirconium/titania catalyst was prepared in the same manner as in Example 1 except that ceria was replaced with zirconium.

The zirconium/titania catalyst was sintered at 500° C. under air atmosphere.

### Comparative Example 3. CeO₂

Zirconia (ZrO₂, Sigma Co.) was prepared.

<Test Example>

### Test Example 1. Yield of Ammonia Depending on Urea Injection Temperature

In order to investigate the urea removal efficiency of the reductant injection system 10 for a selective catalytic reduction reaction of the present disclosure depending on urea injection temperature, ammonia yield (NH₃ yield) was measured under a space velocity condition of 60,000 hr⁻¹ using titania.

The experiment was conducted under the condition of urea concentration=400 ppm, oxygen=3.0 vol. %, carrier gas inflow rate=1000 cc/min, space velocity=60,000 hr⁻¹, catalyst amount=0.5 g and residence time=0.06 second.

The result is shown in FIG. 4.

FIG. 4 shows ammonia yield depending on urea injection temperature. Referring to FIG. 4, it can be seen that the ammonia yield is increased as the urea injection temperature is increased. In particular, the ammonia yield was the most superior when the urea injection temperature was 190° C.

A urea injection temperature exceeding 190° C. may be unfavorable because salts that cannot be decomposed easily such as CYA, ammelide, etc. are formed when urea is introduced.

### Test Example 2. Ammonia Yield (NH3 Yield) Depending on Catalyst

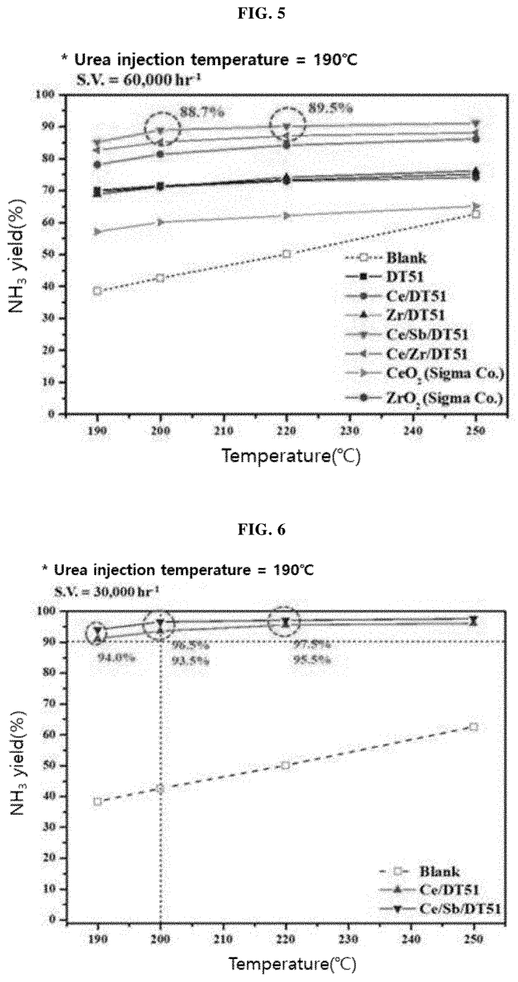

In order to investigate the urea removal efficiency of the catalyst of the present disclosure, ammonia yield (NH₃ yield) was measured for the catalysts prepared in the examples and comparative examples under a space velocity condition of 60,000 hr⁻¹. The result is shown in FIG. 5. The experimental condition and measurement method are as follows.

Experimental Condition

Experiment was conducted under the condition of urea concentration=400 ppm, oxygen=3.0 vol. %, carrier gas inflow rate=1000 cc/min, space velocity=60,000 hr−1, catalyst amount=0.5 g and residence time=0.12 second. The space velocity is a measure of the amount of a gas that can be treated by a catalyst, and is represented as a ratio of the volume of the catalyst with respect to the total amount (volume) of the gas.

Measurement Method

Ammonia yield was calculated according to Equation 2.

$${NH}_{3} yield ( \% ) = \frac{( {C}_{inlet Urea} - {C}_{Outlet Urea} ) - {C}_{outlet Nh 3}}{{C}_{inlet Urea}} \times 100 \qquad [ Equation 2 ]$$

FIG. 5 shows urea decomposition activity depending on the change in the catalyst and carrier gas temperature.

Referring to FIG. 5, it can be seen that the catalysts prepared in the examples have improved ammonia yield as compared to the catalysts prepared in the comparative examples and that the ammonia yield is improved as the temperature of the carrier gas is increased.

In particular, it can be seen that the ceria/zirconium/titania catalyst of Example 2 exhibits an ammonia yield of 88.7% and 89.5% at 200° C. and 220° C., respectively.

### Test Example 3. Ammonia Yield (NH3 Yield) Depending on Catalyst

In order to investigate the urea removal efficiency of the catalyst of the present disclosure, ammonia yield (NH₃ yield) was measured for the catalysts prepared in Examples 1 and 2 under a space velocity condition of 30,000 hr⁻¹. The result is shown in FIG. 6.

The experimental condition and measurement method were the same as in Test Example 2.

FIG. 6 shows the urea decomposition activity depending on the change in the catalyst and carrier gas temperature under the space velocity condition of 30,000 hr−1.

Referring to FIG. 6, it can be seen that the catalysts prepared in Examples 1 and 2 have superior ammonia yield and that the ammonia yield is improved as the temperature of the carrier gas is increased. In particular, it can be seen that the ceria/zirconium/titania catalyst of Example 2 exhibits an ammonia yield of 96.5% and 97.5% at 200° C. and 220° C., respectively.

### Test Example 4. Measurement of Oxygen Composition of Catalyst

The oxygen composition of the urea decomposition catalysts prepared in the examples and comparative examples was measured. Specifically, after measuring lattice oxygen, surface-adsorbed oxygen and total oxygen for each catalyst, O_{α}+O_{β}/Oₜₒₜₐₗ was calculated.

Here, O_{α} represents lattice oxygen, O_{β} represents surface-adsorbed oxygen and Oₜₒₜₐₗ represents total oxygen in the catalyst.

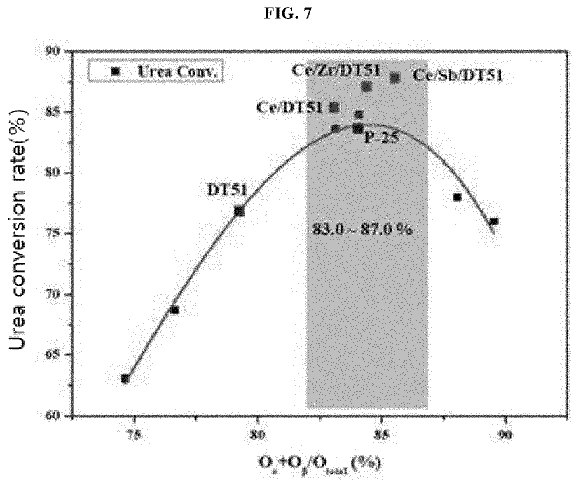

The result is shown in FIG. 7. FIG. 7 shows the correlation between O_{α}+O_{β}/Oₜₒₜₐₗ and urea conversion rate in the examples and comparative examples (injected gas=O₂ 10.0 vol. %, R.H.=50%, N₂ balance).

Referring to FIG. 7, it can be seen that the catalysts prepared in the present disclosure satisfy Equation 1.

0.8<O_{α}+O_{β}/Oₜₒₜₐₗ<0.87 [Equation 1]

In addition, it can be seen that a urea conversion rate of 80% or higher is achieved when Equation 1 is satisfied.

### INDUSTRIAL APPLICABILITY

The present disclosure is industrially applicable because it can be applied for supplying a reductant to a system for removing fine dust.

1. A reductant injection system for a selective catalytic reduction reaction, comprising:
an exhaust gas line wherein an exhaust gas comprising nitrogen oxide (NOₓ) flows;
a urea reservoir provided outside the exhaust gas line, wherein urea is stored; and
a urea injection line for injecting urea from the urea reservoir to the exhaust gas line.

2. The reductant injection system for a selective catalytic reduction reaction of claim 1, wherein the temperature of one point (T₁) of the exhaust gas line connected to the urea injection line is equal to or higher than the temperature for pyrolyzing the urea (T_{d}).

3. The reductant injection system for a selective catalytic reduction reaction of claim 1, wherein the urea injection line is equipped with a catalyst for decomposing the urea to ammonia.

4. The reductant injection system for a selective catalytic reduction reaction of claim 3, wherein:
the catalyst comprises a titania support and ceria supported on titania; and
the catalyst has an oxygen composition satisfying Equation 1,
0.8<O_{α}+O_{β}/Oₜₒₜₐₗ<0.87 [Equation 1]
where O_{α} represents lattice oxygen, O_{β} represents surface-adsorbed oxygen and Oₜₒₜₐₗ represents total oxygen in the catalyst.

5. The reductant injection system for a selective catalytic reduction reaction of claim 4, wherein the urea decomposition catalyst further comprises antimony or zirconia.

6. The reductant injection system for a selective catalytic reduction reaction of claim 4, wherein the urea decomposition catalyst has a ceria content of 5.0-10.0 wt. % based on the total catalyst.

7. The reductant injection system for a selective catalytic reduction reaction of claim 4, wherein the urea decomposition catalyst is sintered at a temperature of 350-450° C. to satisfy the oxygen composition of claim 4.

8. The reductant injection system for a selective catalytic reduction reaction of claim 5, wherein the urea decomposition catalyst further comprises antimony, and the content of antimony is 1.5-2.5 wt. % based on the total catalyst.

9. The reductant injection system for a selective catalytic reduction reaction of claim 8, wherein the urea decomposition catalyst is sintered at a temperature of 550-650° C. to satisfy the oxygen composition of claim 4.

10. The reductant injection system for a selective catalytic reduction reaction of claim 5, wherein the urea decomposition catalyst further comprises zirconia, and the content of zirconia is 1.5-2.5 wt. % based on the total catalyst.

11. The reductant injection system for a selective catalytic reduction reaction of claim 10, wherein the urea decomposition catalyst is sintered at a temperature of 450-550° C. to satisfy the oxygen composition of claim 4.

12. The reductant injection system for a selective catalytic reduction reaction of claim 1, wherein a carrier gas line diverging from the exhaust gas line is connected to the urea injection line, and the exhaust gas of the carrier gas line has a temperature of 180-220° C.

13. A reductant injection system for a selective catalytic reduction reaction, comprising:
an exhaust gas line allowing flow of an exhaust gas;
a urea reservoir storing urea; and
a urea injection line injecting urea from the urea reservoir to the exhaust gas line.

14. The reductant injection system for a selective catalytic reduction reaction of claim 13 further comprising:
a heater formed in the urea injection line pyrolyzing urea injected from the urea reservoir to the exhaust gas line.

15. The reductant injection system for a selective catalytic reduction reaction of claim 13, wherein the temperature of one point (T₁) of the exhaust gas line connected to the urea injection line is equal to or higher than the temperature for pyrolyzing the urea (T_{d}).

16. The reductant injection system for a selective catalytic reduction reaction of claim 13, wherein the urea injection line is equipped with a catalyst for decomposing the urea to ammonia.

17. The reductant injection system for a selective catalytic reduction reaction of claim 16, wherein:
the catalyst comprises a titania support and ceria supported on titania; and
the catalyst has an oxygen composition satisfying Equation 1,
0.8<O_{α}+O_{β}/Oₜₒₜₐₗ<0.87 [Equation 1]
where O_{α} represents lattice oxygen, O_{β} represents surface-adsorbed oxygen and Oₜₒₜₐₗ represents total oxygen in the catalyst.

18. The reductant injection system for a selective catalytic reduction reaction of claim 17, wherein the urea decomposition catalyst further comprises antimony or zirconia.

19. The reductant injection system for a selective catalytic reduction reaction of claim 18, wherein the urea decomposition catalyst further comprises zirconia, and the content of zirconia is 1.5-2.5 wt. % based on the total catalyst.

20. The reductant injection system for a selective catalytic reduction reaction of claim 13, wherein a carrier gas line diverging from the exhaust gas line is connected to the urea injection line, and the exhaust gas of the carrier gas line has a temperature of 180-220° C.
